(19) United States
(12) Patent Application Publication
(10) Pub. No.: US 2010/0166963 A1
(43) Pub. Date: Jul. 1, 2010

(54) METHOD FOR MANUFACTURING WATER-BASED DISPERSION OF SELF-DISPERSING POLYMER, WATER-BASED INK COMPOSITION, INK SET AND IMAGE FORMING METHOD

(76) Inventors: Akio TAMURA, Kanagawa (JP); Takahiro Kato, Kanagawa (JP); Takahiro Ishizuka, Kanagawa (JP); Terukazu Yanagi, Kanagawa (JP)

Correspondence Address: BIRCH STEWART KOLASCH & BIRCH, PO BOX 747, FALLS CHURCH, VA, 22040-0747, US

(21) Appl. No.: 12/631,456

(22) Filed: Dec. 4, 2009

(30) Foreign Application Priority Data
Dec. 26, 2008 (JP) 2008-334491

(51) Int. Cl. C09D 11/02; C08K 5/09; C08K 5/092; C08K 3/10; C08K 3/30; B05D 5/06

(52) U.S. Cl. 427/256; 524/284; 524/321; 524/320; 524/401; 524/423

(57) ABSTRACT

The invention provides a method for manufacturing a water-based dispersion of a self-dispersing polymer, including:
obtaining a copolymer solution including a copolymer having a hydrophilic constituent unit and a hydrophobic constituent unit, and a solvent dissolving that dissolves the copolymer;
obtaining a water-based dispersion of the copolymer through dispersion using the copolymer solution and water; and
adding a water-soluble electrolyte selected from an acidic compound and the salt thereof to either or both of the copolymer solution and the water-based dispersion, as well as a water-based ink composition including the water-based dispersion, an ink set including the water-based ink composition, and an image forming method using the water-based ink composition or the ink set.

### CROSS-REFERENCE TO RELATED APPLICATION

This application claims priority under 35 USC 119 from Japanese Patent Application No. 2008-334491 filed on Dec. 26, 2008, the disclosure of which is incorporated by reference herein.

### BACKGROUND OF THE INVENTION

1. Field of the Invention

The present invention relates to: a method for manufacturing a water-based dispersion containing a self-dispersing polymer; a water-based ink composition; an ink set; and an image forming method.

2. Description of the Related Art

An inkjet recording method performs recording by respectively ejecting ink droplets from a large number of nozzles formed on an inkjet head, and is widely used for the reasons that noise at the time of a recording operation is low, running costs are inexpensive and a high definition image can be recorded on a large variety of recording media.

A carbon black pigment is generally used for a black ink used for inkjet printing. Further, the use of water-soluble dyes for forming color inks is widespread. Improvements in resistance to climactic conditions in terms of properties such as lightfastness, ozone resistance, or water resistance have been required for inkjet inks. Improvement in the weather resistance of inkjet inks is particularly important when the application thereof to the printing field is considered.

Pigments are innately highly robust due to the high crystallinity thereof, and thus have remarkably excellent lightfastness and water resistance as compared with dyes. However, inks using a pigment may cause phenomena such as deterioration in ejectability due to clogging of a nozzle part or the like, deterioration in storage stability due to coagulation and precipitation or the like, or deterioration in fixation property of a printed substance, such as in terms of friction resistance or glossiness, due to particles remaining on a surface of a recording medium.

An aqueous inkjet recording liquid in which a self water-dispersible copolymer resin obtained by copolymerizing an unsaturated monomer having an aliphatic hydrocarbon group having 14 to 20 carbon atoms, a benzyl methacrylate monomer, and a styrene monomer, and which is used in the aqueous inkjet recording liquid in a form of a hydrosol or an emulsion, has been disclosed as a technique for improving the fixation property of an ink (see, for example, Japanese Patent Application Laid-Open (JP-A) No. 2002-88285). JP-A No. 2002-88285 describes that the recording liquid has excellent storage stability, maintains high printing density and printing quality even though a rapid drying property is imparted thereto by penetration drying, and further has excellent abrasion resistance and water resistance.

Moreover, an inkjet recording aqueous ink which contains a self-dispersing pigment and a self-emulsified polymer particle containing a constituent unit derived from an aromatic group-containing monomer has been disclosed (see, for example, JP-A No. 2006-283003). JP-A No. 2006-283003 describes that the ink provides a printed image which exhibits excellent glossiness on customized paper while satisfying a high printing density.

Furthermore, as a method for producing a polymer particle dispersion (latex), a technique of controlling the particle size by adding an electrolyte is disclosed (see, for example, JP-A Nos. 2000-319329 and 53-39387). According to this production method, a latex having a particle size larger than a certain size is described to be obtained with a high yield without by-producing coagulated precipitates.

The ink containing a water dispersion that is described in JP-A No. 2002-88285 or JP-A No. 2006-283003 has a recognizable effect of improving fixability, but in some cases, a stable water dispersion is difficult to obtain. Even if a stable water dispersion is obtained, the viscosity of the resulting water dispersion is high in some cases, so that it is rather difficult, for example, to use it for an inkjet ink.

The methods of producing a latex described in JP-A Nos. 2000-319329 and 53-39387, each includes an addition of an electrolyte to an emulsion polymerization system, so that the particle size of the dispersion becomes in a sub-micron order. Because of this, for example, in the case of an inkjet ink application, ejection stability or storage stability is often lowered.

### SUMMARY OF THE INVENTION

The present invention has been made in view of the above circumstances and provides: a method for manufacturing a water-based dispersion of a self-dispersing polymer; a water-based ink composition; an ink set; and an image forming method.

A first aspect of the present invention provides a method for manufacturing a water-based dispersion of a self-dispersing polymer, comprising:

obtaining a copolymer solution comprising a copolymer having a hydrophilic constituent unit and a hydrophobic constituent unit, and a solvent that dissolves the copolymer; obtaining a water-based dispersion of the copolymer through dispersion using the copolymer solution and water; and

adding a water-soluble electrolyte selected from an acidic compound and a salt thereof to either or both of the copolymer solution and the water-based dispersion.

A second aspect of the present invention provides a water-based ink composition, comprising:

water-insoluble colored particles comprising a coloring agent; and

a water-based dispersion of a self-dispersing polymer produced by the method for manufacturing a water-based dispersion of a self-dispersing polymer according to the first aspect of the present invention.

A third aspect of the present invention provides an ink set, comprising:

at least one kind of the water-based ink composition according to the second aspect of the present invention.

A fourth aspect of the present invention provides an image forming method, comprising:

applying the water-based ink composition according to the second aspect of the present invention on a recording medium by using the water-based ink composition according to the second aspect of the present invention or the ink set according to in the third aspect of the present invention.

### DETAILED DESCRIPTION OF THE INVENTION

### Method for Manufacturing Water-Based Dispersion of a Self-Dispersing Polymer

The method for manufacturing a water-based dispersion of a self-dispersing polymer according to the present invention includes: a step of obtaining a copolymer solution containing a coploymer having a hydrophilic constituent unit and a hydrophobic constituent unit, and a solvent that dissolves the copolymer; a dispersing step of obtaining a water-based dispersion of the copolymer by using the copolymer solution and water; and a step of adding a water-soluble electrolyte selected from an acidic compound and a salt thereof to either or both of the copolymer solution and the water-based dispersion.

Owing to this configuration, a water-based dispersion of a self-dispersing polymer having an excellent dispersion stability is allowed to be produced efficiently.

In the manufacturing method according to the present invention, a water-soluble electrolyte is added to either or both of the copolymer solution and the water-based dispersion, so that, for example, the thickness of the electrical double layer contributing to dispersion is regulated and the particle size of the dispersed copolymer particles become appropriate for dispersion. Whereby, a water-based dispersion of a self-dispersing polymer having an excellent dispersion stability may be considered to be produced.

[Self-Dispersing Polymer]

The self-dispersing polymer of the present invention denotes a copolymer having a hydrophilic constituent unit and a hydrophobic constituent unit, which is a water-insoluble polymer capable of being in a dispersion state in the absence of a surfactant in a water-based medium by an action of a hydrophilic functional group of the polymer itself (preferably, a dissociative group or its salt). The self-dispersing polymer is preferably a copolymer derived from a monomer having an ethylenically unsaturated bond. The dispersion state described herein includes both an emulsion state (emulsion) in which a water-insoluble polymer is dispersed in a liquid state in a water-based medium and a dispersion state (suspension) in which a water-insoluble polymer is dispersed in a solid state in a water-based medium.

The self-dispersing polymer is, for example, from the viewpoint of ink fixability when it is incorporated in a water-based ink composition, preferably a self-dispersing polymer that is allowed to exist in a dispersion state in which the water-insoluble polymer is dispersed in a solid state.

The dispersion state of the self-dispersing polymer denotes a state that is recognizable by visual observation that the dispersion state stably exists for at least one week at 25° C., even after a solution obtained by dissolving 30 g of the water-insoluble polymer in 70 g of an organic solvent (for example, methyl ethyl ketone), a neutralizer capable of neutralizing 100% of the dissociative group of the water-insoluble polymer (sodium hydroxide when the dissociative group is anionic, or acetic acid when the dissociative group is cationic), and 200 g of water are mixed and agitated (apparatus: an agitator with agitation propellers, at a revolution of 200 rpm for 30 minutes at 25° C.) and then the organic solvent is removed from the resulting mixed liquid.

The water-insoluble polymer is a polymer characterized in that the dissolution amount of the polymer is 10 g or less when the polymer is dried at 105° C. for 2 hours and dissolved in 100 g of water at 25° C. The dissolution amount is preferably 5 g or less, and more preferably 1 g or less. The dissolution amount is the one obtained when the polymer is neutralized by 100% with sodium hydroxide or acetic acid depending on the kind of the dissociative group of the water-insoluble polymer.

[Water-Soluble Electrolyte]

In the method for manufacturing a water-based dispersion of a self-dispersing polymer according to the present invention, at least one kind water-soluble electrolyte selected from an acidic compound and a salt thereof is added to either or both of the copolymer solution and the water-based dispersion. The water-soluble electrolyte is selected from an acidic compound and a salt thereof, which is not particularly limited as long as the compound is allowed to be dissolved in water and has a functional group that is dissociable when the compound is dissolved in water. The compound may be an organic compound or an inorganic compound. Note that, “water-soluble” described herein denotes that 5 g or more are dissolved in 100 g of water at 25° C.

Furthermore, the water-soluble electrolyte is different from a compound that is used as a neutralization base for neutralizing an anionic dissociative group that the foregoing copolymer may contain (for example, a basic compound such as an alkali metal hydroxide, ammonia, or an organic amine compound), and is a compound that does not work substantially as a neutralization base.

Examples of the water-soluble electrolyte of the present invention may include an acidic compound such as a carboxylic acid derivative, a sulfonic acid derivative, a phosphoric acid derivative, or an inorganic acid, and a compound that is obtained when an acidic functional group of the acidic compound forms a salt. The molecular weight of the acidic compound is not particularly limited, but from the viewpoint of dispersion stability, it is preferably 1,000 or less, more preferably 500 or less, and still more preferably 300 or less.

Examples of the cation that forms a salt with the acidic compound may include an alkali metal ion such as sodium ion or potassium ion, ammonium ion (NH₄⁺), and an aminoalcohol ion such as monoethanol ammonium ion (HOCH₂CH₂NH₃⁺). The cation that forms a salt may be used one kind alone or in a combination of two or more kinds.

In addition, the water-soluble electrolyte may be a mixture of the acidic compound and the salt thereof. Namely, an acidic compound in which the acidic functional group thereof partly forms a salt may be included.

Specific examples of the water-soluble electrolyte may include: a carboxy group-containing acidic compound such as acrylic acid, methacrylic acid, maleic acid, malic acid, tartaric acid, fumaric acid, or lactic acid and a salt thereof; a sulfonyl group-containing acidic compound such as metanesulfonic acid or p-toluenesulfonic acid and a salt thereof and an inorganic acid salt such as NaCl, KCl, Na₂SO₄, CaCl₂, or AlCl₃.

Among these, from the viewpoint of dispersion stability, at least one kind selected from a carboxy group containing acidic compound, a salt thereof, and an inorganic acid salt is preferable; at least one kind selected from a carboxy group containing acidic compound having a molecular weight of 500 or less, a salt thereof, and an inorganic acid salt is more preferable; and at least one kind selected from maleic acid, malic acid, tartaric acid, Na salts thereof, NaCl, or Na₂SO₄ is still more preferable.

Note that, the water-soluble electrolyte may be used one kind alone or in a combination of two or more kinds.

In the present invention, the step of adding the water-soluble electrolyte may be incorporated in any stage in the course of the manufacturing process of the water-based dispersion of a self-dispersing polymer of the present invention. For example, the water-soluble electrolyte may be added in the step of obtaining a copolymer solution that contains the copolymer and a solvent that dissolves the copolymer, in the dispersing step of obtaining the water-based dispersion by adding water to the copolymer solution, or after the dispersing step.

In the present invention, from the viewpoint of manufacturing efficiency, the step of adding the water-soluble electrolyte is preferably a step of adding the water-soluble electrolyte to the copolymer solution in which the copolymer is dissolved in the solvent that dissolves the copolymer.

Regarding the addition amount of the water-soluble electrolyte, the water-soluble electrolyte is added in a manner that the content thereof becomes, from the viewpoint of dispersion stability of the water-based dispersion of a self-dispersing polymer, preferably from 0.01% by mass to 10% by mass with respect to the self-dispersing polymer resin, and more preferably from 0.02% by mass to 5% by mass.

When the content of the water-soluble electrolyte is 10% by mass or less, the water-based dispersion of a self-dispersing polymer is allowed to be prevented from being coagulated, fused, and precipitated. On the other hand, when the content of the water-soluble electrolyte is 0.01% by mass or more, the thickness of an electrical double layer is regulated, so that fine particles having a particle size enabling stable dispersing in a water-based medium become formable. Namely, in the range of from 0.01% by mass to 10% by mass, a water-based dispersion of a self-dispersing polymer having a high stability that is difficult to obtain by conventional arts is obtainable.

In the present invention, when a carboxylic acid derivative or a salt thereof is used as the water-soluble electrolyte, the content of the water-soluble electrolyte is preferably from 0.03% by mass to 8% by mass and more preferably from 0.05% by mass to 5% by mass. Further, when an inorganic acid or a salt thereof is used as the water-soluble electrolyte, the content of the water-soluble electrolyte is preferably from 0.02% by mass to 7% by mass and more preferably 0.04% by mass to 4% by mass.

The copolymer solution of the present invention contains at least one kind of copolymer that contains a hydrophilic constituent unit and a hydrophobic constituent unit, and at least one kind of solvent that dissolves the copolymer. The copolymer solution is obtainable by dissolving the copolymer of the present invention in the solvent that dissolves the copolymer. The dissolving method is not particularly limited, and conventional dissolving methods are usable.

The solvent is not particularly limited as long as it is capable of dissolving the copolymer. For example, an organic solvent (hereinafter, also referred to as “organic good solvent” in some cases) having a solubility of 10% by mass or more at 25° C. to the copolymer may be mentioned.

In the present invention, examples of the organic good solvent may include: a ketone-based solvent such as methyl ethyl ketone or acetone; an ether-based solvent such as 1,3-dioxane, 1,4-dioxane, 1,3-dioxolan, or tetrahydrofuran; an ester-based solvent such as ethyl acetate; and an amide-based solvent such as dimethyllacetamide, dimethylformamide, or N-methylpyrrolidone. In the present invention, at least one kind selected from a ketone-based solvent, an ether-based solvent, and an ester-based solvent is preferable; at least one kind selected from a ketone-based solvent, an ether-based solvent, or an ester-based solvent each having a boiling point of 100° C. or lower, is more preferable; and at least one kind selected from methyl ethyl ketone, acetone, 1,3-dioxane, 1,4-dioxane, tetrahydrofuran, or ethyl acetate is still more preferable.

Note that, the organic good solvent may be used one kind alone or in a combination of two or more kinds.

In the present invention, as the solvent that dissolves the copolymer, the organic good solvent may be used in combination with a solvent (hereinafter, referred to as “organic poor solvent” in some cases) that has a small solubility to the copolymer. The organic poor solvent described herein denotes an organic solvent that has a solubility (at 25° C.) of less than 10% by mass to the copolymer.

Examples of the organic poor solvent may include an alcohol solvent such as ethanol, isopropyl alcohol, n-butanol, s-butanol, t-butanol, or 2-ethylhexanol. Among these, an alcohol solvent having a boiling point of 100° C. or lower is preferable, and at least one kind selected from ethanol, isopropyl alcohol, or t-butanol is more preferable.

Note that, the organic poor solvent may be used one kind alone or in a combination of two or more kinds.

In the present invention, when the organic poor solvent is used in combination, from the viewpoint of dispersion stability of the water-based dispersion of a self-dispersing polymer, the content of the organic poor solvent in the solvent that dissolves the copolymer is preferably from 30% by mass to 70% by mass and more preferably from 30% by mass to 60% by mass.

In the present invention, the copolymer solution may further contain at least one kind of neutralizer.

The neutralizer is used to partially or completely neutralize of the dissociative group that the copolymer (self-dispersing polymer) may have therein and to allow the self-dispersing polymer to form a stable dispersion state in a water-based medium.

Examples of the neutralizer to be used when the self-dispersing polymer of the invention has an anionic dissociative group include basic compounds, such as an organic amine compound, ammonia, and an alkali metal hydroxide. Examples of the organic amine compound include monomethylamine, dimethylamine, trimethylamine, monoethylamine, diethylamine, triethylamine, monopropylamine, dipropylamine, monoethanolamine, diethanolamine, triethanolamine, N,N-dimethyl-ethanolamine, N,N-diethyl-ethanolamine, 2-dimethylamino-2-methyl-1-propanol, 2-amino-2-methyl-1-propanol, N-methyldiethanolamine, N-ethyldiethanolamine, monoisopropanolamine, diisopropanolamine, and tri-isopropanolamine. Examples of the alkali metal hydroxide include lithium hydroxide, sodium hydroxide, and potassium hydroxide. Particularly, from the viewpoint of dispersion stability in water of the self-dispersing polymer particles of the invention, sodium hydroxide, potassium hydroxide, ammonia, triethylamine, and triethanolamine are preferable.

These neutralizers (preferably, basic compounds) are preferably used in an amount of from 5 mol % to 120 mol % with respect to 100 mol % of the dissociative group, more preferably from 10 mol % to 110 mol %, and still more preferably from 15 mol % to 100 mol %. When the amount of the neutralizer is 15 mol % or more, an effect of stabilizing particle dispersion in water is remarkably developed. When the amount of the neutralizer is 100 mol % or less, water-soluble components that are in a dispersion state are markedly minimized, thereby providing an effect of suppressing the viscosity of dispersion liquid from being increased.

In the present invention, the dispersing step is preferably a step in which a water-based dispersion is prepared by mixing and agitation while at least water is added to the copolymer solution. In this way, by adding water to the copolymer solution in which the copolymer is dissolved in a solvent, a water-based dispersion of a self-dispersing polymer that has a still higher dispersion stability is obtainable without requiring an intense shearing force.

In the present invention, the method of agitating the mixture is not particularly limited, and conventional mixing agitators, if necessary, ultrasonic dispersers or high pressure homogenizers are usable.

In the present invention, at least water is added to the copolymer solution, but in addition to water, a neutralizer or an organic solvent (preferably, organic poor solvent) may be further added.

The method for manufacturing a water-based dispersion of a self-dispersing polymer according to the present invention preferably includes a solvent removal step after the dispersing step. The solvent removal step is not particularly limited as long as the solvent is at least partially removed, and conventional processes, for example, distillation, vacuum distillation, or the like are applicable.

In the present invention, by including the solvent removal step, a water-based dispersion of a self-dispersing polymer having a still higher dispersion stability is obtainable.

In the solvent removal step of the present invention, the solvent is at least partially removed, but water may be partially removed along with the solvent.

In the present invention, the solvent removal step is a step in which the solvent is removed in a manner that the content of the solvent in the water-based dispersion of a self-dispersing polymer becomes preferably from 0.05% by mass to 10% by mass with respect to the solid content of the copolymer, and more preferably from 0.08% by mass to 8% by mass.

The average particle diameter of the self-dispersing polymer particles in the water-based dispersion of a self-dispersing polymer of the present invention is preferably in a range of from 0.1 nm to 80 nm, more preferably from 0.2 nm to 60 nm, and still more preferably from 0.3 nm to 40 nm. When the average diameter is 0.1 nm or more, production adaptability is improved, thereby enabling the water-based dispersion not to become highly viscous. When the average diameter is 80 nm or less, storage stability is improved. On the other hand, in the case of less than 0.1 nm, interaction between particles increases largely and the viscosity of the water-based dispersion increases, thereby possibly introducing lowering in production efficiency. In addition, from the viewpoint of ejection properties, such a water-based dispersion is not appropriate for a water-based ink composition. When the average particle diameter exceeds 80 nm, fusion among polymer particles occurs frequently and the number of micron-size crude particles increases, thereby becoming difficult to keep a stable dispersion state.

In the present invention, there is not any particular limitation on the particle size distribution of the self-dispersing polymer particles, and the particles may have a wide particle size distribution or may have a monodispersed particle size distribution. Further, two or more kinds of self-dispersing polymer resins (copolymers) may be mixed and included.

Note that, the average particle diameter and the particle size distribution of the self-dispersing polymer particles are measurable, for example, by using a dynamic light scattering method.

Hereinafter, the copolymer that composes the self-dispersing polymer of the present invention will be described.

The self-dispersing polymer (copolymer) of the present invention contains at least one kind of hydrophilic constituent unit and at least one kind of hydrophobic constituent unit.

At least one kind among the hydrophobic constituent units is, from the viewpoint of dispersion stability, preferably a constituent unit derived from a monomer that has an ethylenically unsaturated bond, and more preferably a constituent unit derived from either or both of an acrylic acid ester monomer and a methacrylic acid ester monomer.

Specific examples of the monomer that composes the hydrophobic constituent unit may include: styrene, α-methylstyrene, methyl acrylate, ethyl acrylate, n-propyl acrylate, isopropyl acrylate, n-butyl acrylate, isobutyl acrylate, sec-butyl acrylate, tert-butyl acrylate, amyl acrylate, hexyl acrylate, 2-ethylhexyl acrylate, octyl acrylate, tert-octyl acrylate, 2-chloroethyl acrylate, 2-bromoethyl acrylate, 4-chlorobutyl acrylate, cyanoethyl acrylate, 2-acetoxyethyl acrylate, benzyl acrylate, methoxybenzyl acrylate, 2-chlorocyclohexyl acrylate, cyclohexyl acrylate, furfuryl acrylate, tetrahydrofurfuryl acrylate, phenyl acrylate, 2-phenoxyethyl acrylate, 5-hydroxypentyl acrylate, 2,2-dimethyl-3-hydroxypropyl acrylate, 2-methoxyethyl acrylate, 3-methoxybutyl acrylate, 2-ethoxyethyl acrylate, 2-butoxyethyl acrylate, 2-(2-methoxyethoxy)ethyl acrylate, 2-(2-butoxyethoxy)ethyl acrylate, glycidyl acrylate, 1-bromo-2-methoxyethyl acrylate, 1,1-dichloro-2-ethoxyethyl acrylate, 2,2,2-tetrafluoroethyl acrylate, 1H,1H,2H,2H-perfluorodecyl acrylate, methyl methacrylate, ethyl methacrylate, n-propyl methacrylate, isopropyl methacrylate, n-butyl methacrylate, isobutyl methacrylate, sec-butyl methacrylate, tert-butyl methacrylate, amyl methacrylate, hexyl methacrylate, benzyl methacrylate, chlorobenzyl methacrylate, octyl methacrylate, stearyl methacrylate, 2-(3-phenylpropyloxy)ethyl methacrylate, furfuryl methacrylate, tetrahydrofurfuryl methacrylate, phenyl methacrylate, 2-phenoxyethyl methacrylate, cresyl methacrylate, naphthyl methacrylate, 2-hydroxyethyl methacrylate, 4-hydroxybutyl methacrylate, triethyleneglycol monomethacrylate, dipropyleneglycol monomethacrylate, 2-methoxyethyl methacrylate, 3-methoxybutyl methacrylate, 2-ethoxyethyl methacrylate, methoxydiethyleneglycol methacrylate, 2-iso-propoxyethyl methacrylate, 2-butoxyethyl methacrylate, 2-(2-methoxyethoxy)ethyl methacrylate, 2-(2-ethoxyethoxy)ethyl methacrylate, 2-(2-butoxyethoxy)ethyl methacrylate, 2-acetoxyethyl methacrylate, 2-acetoacetoxyethyl methacrylate, allyl methacrylate, glycidyl methacrylate, 2,2,2-tetrafluoroethyl methacrylate, and 1H,1H,2H,2H-perfluorodecyl methacrylate.

In addition, the other specific examples of the monomer that composes the hydrophobic constituent unit may include the following esters of acrylic acid and methacrylic acid respectively: cyclohexyl, cyclohexylmethyl, 3-cyclohexenylmethyl, 4-isopropylcyclohexyl, 1-methylcyclohexyl, 2-methylcyclohexyl, 3-methylcyclohexyl, 4-methylcyclohexyl, 1-ethylcyclohexyl, 4-ethylcyclohexyl, 2-tert-butylcyclohexyl, 4-tert-butylcyclohexyl, menthyl, 3,3,5-trimethylcyclohexyl, cycloheptyl, cyclo-octyl, nonyl, cyclodecyl, 2-norbonyl, isobonyl, 3-methyl-2-norbonyl, dicylopentanyl, dicyclopentenyl, dicyclopentenyloxyethyl, adamantan-1-yl, adamantan-2-yl, 2-methyladamantan-2-yl, 2-ethyladamantan-2-yl, 3,5-dimethyladamantan-1-yl, and 1,1′-bisadamantan-3-yl.

In the present invention, the self-dispersing polymer contains at least one kind of hydrophilic constituent unit. The hydrophilic constituent unit is preferably derived from a monomer having an ethylenically unsaturated bond, and may be derived from one kind of monomer having a hydrophilic group or two or more kinds of monomers having a hydrophilic group. The hydrophilic group is not particularly limited and may be a dissociative group or a nonionic hydrophilic group.

In the present invention, the hydrophilic group is, from the viewpoint of promoting self-dispersibility and the stability of resulting emulsion state or dispersion state, preferably a dissociative group, and more preferably an anionic dissociative group. Examples of the dissociative group include a carboxy group, a phosphoric acid group, a sulfonic acid group, or the like. Among these, from the viewpoint of fixability of a resulting water-based ink composition, a carboxy group is preferable.

In the present invention, the monomer having a hydrophilic group is, from the viewpoint of self-dispersibility, preferably a dissociative group-containing monomer, and more preferably a dissociative group-containing monomer that contains a dissociative group and an ethylenically unsaturated bond.

Examples of the dissociative group-containing monomer may include an unsaturated carboxylic acid monomer, an unsaturated sulfonic acid monomer, and an unsaturated phosphoric acid monomer.

Specific examples of the unsaturated carboxylic acid monomer include acrylic acid, methacrylic acid, crotonic acid, itaconic acid, maleic acid, fumaric acid, citraconic acid, and 2-methacryloyloxy methylsuccinic acid. Specific examples of the unsaturated sulfonic acid monomer include styrenesulfonic acid, 2-acrylamido-2-methylpropanesulfonic acid, 3-sulfopropyl (meth)acrylate, and bis-(3-sulfopropyl)-itaconate. Specific examples of the unsaturated phosphoric acid monomer include vinylphosphonic acid, vinyl phosphate, bis(methacryloxyethyl) phosphate, diphenyl-2-acryloyloxy ethyl phosphate, diphenyl-2-methacryloyloxy ethyl phosphate, and dibutyl-2-acryloyloxy ethyl phosphate.

Among the above dissociative group-containing monomers, an unsaturated carboxylic acid monomer is preferable, and acrylic acid and methacrylic acid are more preferable from the viewpoint of improvement in dispersion stability and ejection stability.

The range of the molecular weight of the self-dispersing polymer in the invention is preferably from 3,000 to 200,000, more preferably from 5,000 to 150,000, and still more preferably from 10,000 to 100,000 in terms of weight average molecular weight. When the weight average molecular weight is adjusted to 3,000 or more, the amount of water-soluble component can be effectively suppressed. Moreover, when the weight average molecular weight is adjusted to 200,000 or less, the self-emulsification stability can be increased.

The weight average molecular weight can be measured by gel permeation chromatography (GPC).

Specific examples of the self-dispersing polymer (Compounds B-01 to B-10) are shown below, while the invention is not limited thereto. The ratio in the parentheses indicates the mass ratio of copolymerization components.

B-01: methyl methacrylate/2-methoxyethyl acrylate/benzyl methacrylate/methacrylic acid copolymer (47/10/35/8),

B-02: methyl methacrylate/styrene/benzyl methacrylate/methacrylic acid copolymer (59/15/20/6),

B-03: phenoxyethyl acrylate/methyl methacrylate/acrylic acid copolymer (50/45/5),

B-04: methyl methacrylate/dicyclopentanyl methacrylate/benzyl methacrylate/methacrylic acid copolymer (43/16/35/6),

B-05: methyl methacrylate/isobornyl methacrylate/methacrylic acid copolymer (40/52/8),

B-06: styrene/phenoxyethyl acrylate/methyl methacrylate/acrylic acid copolymer (10/50/35/5),

B-07: benzyl acrylate/methyl methacrylate/acrylic acid copolymer (55/40/5),

B-08: phenoxyethyl methacrylate/benzyl acrylate/methacrylic acid copolymer (45/47/8),

B-09: styrene/phenoxyethyl acrylate/butyl methacrylate/acrylic acid copolymer (5/48/40/7), and

B-10: benzyl methacrylate/isobutyl methacrylate/cyclohexyl methacrylate/methacrylic acid copolymer (35/30/30/5).

In the present invention, the method for synthesizing the self-dispersing polymer is not particularly limited, and the self-dispersing polymer may be synthesized by copolymerizing a monomer mixture by a known polymerization method such as solution polymerization or bulk polymerization. Among these polymerization methods, from the viewpoint of droplet ejection stability of a resulting water-based ink composition, solution polymerization is preferable. For example, a mixture that contains a monomer mixture and, if necessary an organic solvent and a radical polymerization initiator may be subjected to copolymerization in an inert gas atmosphere so as to synthesize the self-dispersing polymer.

The synthesized self-dispersing polymer may be rendered to a water-based dispersion of a self-dispersing polymer through the method for manufacturing a water-based dispersion of a self-dispersing polymer according to the present invention.

The water-based dispersion of a self-dispersing polymer that is produced by the method for manufacturing a water-based dispersion of a self-dispersing polymer according to the present invention has an excellent dispersion stability. Therefore, for example, an ink composition that contains the water-based dispersion of a self-dispersing polymer is capable of exhibiting an excellent storage stability and further exhibiting an adequate ink fixability, further, when applied to an inkjet ink composition, in addition to the storage stability and ink fixability, an excellent ejection stability is obtainable.

The water-based dispersion of a self-dispersing polymer of the present invention may be used one kind alone or in a combination of two or more kinds.

<Water-Based Ink Composition>

The water-based ink composition of the present invention contains at least one kind of water-insoluble colored particles that contain a coloring agent, and at least one kind of the water-based dispersion of a self-dispersing polymer. By incorporating the water-based dispersion of a self-dispersing polymer that is produced by the manufacturing method according to the present invention, the ink composition is provided with an excellent storage stability, and a resulting image is provided with an improved fixability.

The water-based ink composition of the invention can be used in not only monochromatic image formation, but also full color image formation. To form a full color image, a magenta tone ink, a cyan tone ink and a yellow tone ink can be used, and to adjust the color tone, a black tone ink may further be used. Furthermore, other than the yellow, magenta and cyan tone inks, red, green, blue and white color inks and so-called specific color inks in printing field (for example, colorless) can be used.

A method for recording an image using the water-based ink composition of the invention is not particularly limited, and a conventional image recording methods can be used. The image recording method that can be used includes a method of applying a water-based ink composition to a recording medium by a means such as an inkjet method, a mimeograph method or a transfer printing method.

(A) Water-Insoluble Colored Particles

In the present invention, the water-insoluble colored particles contain at least one kind of coloring agent. As the coloring agent, known dyes, pigments, and the like are usable without any particular limitation. Among these, from the viewpoint of ink coloring property, a slightly water-soluble or water-insoluble coloring agent is preferable. Specific examples thereof may include various kinds of pigments, disperse dyes, oil-soluble dyes, and pigments that form a J-aggregate. Pigments are more preferable.

In the present invention, a water-insoluble pigment as itself or a water-insoluble pigment that has been surface-treated with a dispersant is usable as the water-insoluble colored particles.

The pigment that may be used in the invention is not particularly limited in its kind, and any one of the conventionally known organic and inorganic pigments may be used. Examples of the pigment that may be used include polycyclic pigments such as azo lake, azo pigment, phthalocyanine pigment, perylene and perynone pigments, anthraquinone pigment, quinacridone pigment, dioxadine pigment, diketopyrrolopyrrole pigment, thioindigo pigment, isoindolinone pigment and quinophthalone pigment; dye lakes such as basic dye type lake and acidic dye type lake; organic pigments such as nitro pigment, nitroso pigment, aniline black and daylight fluorescent pigment; and inorganic pigments such as titanium oxide, iron oxide type and carbon black type. Even pigments that are not described in Color Index can be used so long as it is a pigment capable of being dispersed in an aqueous phase. Furthermore, those obtained by surface treating the above-described pigments with a surfactant, a polymeric dispersant or the like, and grafted carbon can also be used. Among the above pigments, azo pigment, phthalocyanine pigment, anthraquinone pigment, quinacridone pigment and carbon black type pigment are preferably used.

—Dispersant—

When the colorant used in the invention is a pigment, the pigment is preferably dispersed in an aqueous solvent by a dispersant. The dispersant may be a polymer dispersant, or a low molecular weight surfactant type dispersant. The polymer dispersant may be either one of a water-soluble dispersant or a water-insoluble dispersant.

The low molecular weight surfactant type dispersant (hereinafter sometimes referred to as a “low molecular dispersant”) can be added for the purpose of stably dispersing the organic pigment in a water solvent while maintaining an ink in low viscosity. The low molecular dispersant used herein means a low molecular dispersant having a molecular weigh of 2,000 or less. The molecular weight of the low molecular dispersant is preferably from 100 to 2,000, and more preferably from 200 to 2,000.

The low molecular dispersant has a structure containing a hydrophilic group and a hydrophobic group. At least one of each of the hydrophilic group and the hydrophobic group may be independently contained in one molecule, and the low molecular dispersant may have plural kinds of the hydrophilic group and the hydrophobic group. The low molecular dispersant can appropriately have a linking group for linking the hydrophilic group and the hydrophobic group.

Examples of the hydrophilic group include an anionic group, a cationic group, a nonionic group, and a betaine type combining them.

The anionic group is not particularly limited so long as it has a negative charge. A phosphoric acid group, a phosphonic acid group, a phosphinic acid group, a sulfuric acid group, a sulfonic acid group, a sulfuric acid group and a carboxy group are preferred, a phosphoric acid group and carboxy group are more preferred, and a carboxy group is further preferred.

The cationic group is not particularly limited so long as it has a positive charge. An organic cationic substituent is preferred, a cationic group containing nitrogen or phosphorus is more preferred, and a cationic group having nitrogen is further preferred. Above all, pyridinium cation and ammonium cation are particularly preferred.

The nonionic group is not particularly limited so long as it does not have negative or positive charge. Examples of the nonionic group include polyalkylene oxide, polyglycerin and a part of sugar unit.

It is preferred in the invention that the hydrophilic group is an anionic group from the standpoints of dispersion stability and aggregation properties of a pigment.

When the low molecular dispersant has an anionic hydrophilic group, its pKa is preferably 3 or more from the standpoint of contacting with an acidic treating liquid to accelerate an aggregation reaction. The pKa of the low molecular dispersant in the invention is a value experimentally obtained from a titration curve by titrating a liquid obtained by dissolving 1 mmol/liter of a low molecular dispersant in a tetrahydrofuran-water=3:2 (V/V) solution, with an acid or alkali aqueous solution.

Theoretically, when pKa of a low molecular weight dispersant is 3 or more, 50% or more of anionic groups are in a non-dissociation state when contacted with a treating liquid having a pH of about 3. Therefore, water solubility of the low molecular weight dispersant is remarkably decreased, and an aggregation reaction occurs. In other words, aggregation reactivity is improved. From this standpoint, it is preferred that the low molecular dispersant has a carboxy group as an anionic group.

On the other hand, the hydrophobic group may have any structure of hydrocarbon type, fluorocarbon type, silicone type and the like, and the hydrocarbon type is particularly preferred. The hydrophobic groups may have any of a linear structure and a branched structure. The hydrophobic group may have a one chain structure or a structure having two or more chains. Where the structure has two or more chains, the structure may have plural kinds of hydrophobic groups.

The hydrophobic group is preferably a hydrocarbon group having from 2 to 24 carbon atoms, more preferably a hydrocarbon group having from 4 to 24 carbon atoms, and further preferably a hydrocarbon group having from 6 to 20 carbon atoms.

Among the polymer dispersants which can be used in the invention, a hydrophilic polymer compound can be used as the water-soluble dispersant. Examples of a natural hydrophilic polymer compound include vegetable polymers such as gum Arabic, gum tragacanth, gum guar, gum karaya, locust bean gum, arabinogalactan, pectin and quince seed starch; seaweed polymers such as alginic acid, carrageenan and agar; animal polymers such as gelatin, casein, albumin and collagen; and microbial polymers such as xanthene gum and dextran.

Examples of a chemically modified hydrophilic polymer compound using a natural product as a raw material include cellulose polymers such as methyl cellulose, ethyl cellulose, hydroxyethyl cellulose, hydroxypropyl cellulose and carboxymethyl cellulose; starch polymers such as starch sodium glycolate and starch sodium phosphate ester; and seaweed polymers such as propylene glycol alginate ester.

Examples of a synthetic water-soluble polymer compound include vinyl polymers such as polyvinyl alcohol, polyvinyl pyrrolidone or polyvinyl methyl ether; acrylic resins such as polyacrylamide, polyacrylic acid or its alkali metal salt, or water-soluble styrene acrylic resin; water-soluble styrene maleic acid resins; water-soluble vinylnaphthalene acrylic resins; water-soluble vinylnaphthalene maleic acid resins; polyvinyl pyrrolidone, polyvinyl alcohol, alkali metal salts of β-naphthalenesulfonic acid formalin condensate; and polymer compounds having a salt of a cationic functional group such as quaternary ammonium or an amino group in the a side chain.

Among these, from the viewpoint of dispersion stability of pigments, a carboxy group containing polymer compound is preferable. For example, an acrylic resin such as a water-soluble styrene-acryl resin; a water-soluble styrene-maleic acid resin; a water-soluble vinyl naphthalene-acryl resin; and a water-soluble vinyl naphthalene-maleic acid resin is particularly preferable.

Among the polymer dispersants, as a water-insoluble dispersant, a polymer having both a hydrophilic moiety and a hydrophobic moiety may be used. Examples of such a polymer include styrene-(meth)acrylic acid copolymer, styrene-(meth)acrylic acid-(meth)acrylic acid ester copolymer, (meth)acrylic acid ester-(meth)acrylic acid copolymer, polyethylene glycol (meth)acrylate-(meth)acrylic acid copolymer and styrene-maleic acid copolymer.

The weight average molecular weight of the polymer dispersant used in the invention is preferably from 3,000 to 200,000, more preferably from 5,000 to 100,000, further preferably from 5,000 to 80,000, and particularly preferably from 10,000 to 60,000.

The mixing mass ratio of a pigment to a dispersant (pigment:dispersant) is preferably in a range of from 1:0.06 to 1:3, more preferably in a range of from 1:0.125 to 1:2, and further preferably in a range of from 1:0.125 to 1:1.5.

When a dye is used as the colorant in the invention, a material in which a water-insoluble carrier supports a dye can be used as water-insoluble colored particles. As the dye, known dyes may be used without particular limitation. For example, dyes described in JP-A No. 2001-115066, JP-A No. 2001-335714 and JP-A No. 2002-249677 can preferably be used in the invention. The carrier used is not particularly limited so long as it is insoluble or sparingly soluble in water, and inorganic materials, organic materials and their composite materials can be used. Specifically, carriers described in, for example, JP-A No. 2001-181549 and JP-A No. 2007-169418 can preferably be used in the invention.

The carrier that supports a dye (water-insoluble colored particles) can be used as a water-based dispersion using a dispersant. As the dispersant, any of the dispersants described hereinabove can be preferably used.

In the present invention, the water-insoluble colored particles contain, from the viewpoints of light fastness and quality of images, preferably a pigment and a dispersant, more preferably an organic pigment and a polymer dispersant, and particularly preferably an organic pigment and a polymer dispersant that contains a carboxy group.

The water-insoluble colored particles used in the invention preferably have an average particle diameter of from 10 nm to 200 nm, more preferably from 10 nm to 150 nm, and further preferably from 10 nm to 100 nm. When the average particle diameter is 200 nm or less, color reproducibility becomes better, and in the case of an inkjet method, droplet ejection properties become better. Furthermore, when the average particle diameter is 10 nm or more, light fastness becomes better.

The particle size distribution of the water-insoluble colored particles is not particularly limited, and may be any of wide particle size distribution and monodispersed particle size distribution. A mixture of two kinds or more of water-insoluble colored particles having monodispersed particle size distribution may be used.

The average particle diameter and the particle size distribution of the water-insoluble colored particles can be measured using, for example, a light scattering method.

In the present invention, the water-insoluble colored particles may be used one kind alone or in a combination of two or more kinds.

The content of the water-insoluble colored particles is, from the viewpoint of image density, preferably from 1% by mass to 25% by mass, with respect to the water-based ink composition, more preferably from 2% by mass to 20% by mass, still more preferably from 5% by mass to 20% by mass, and particularly preferably from 5% by mass to 15% by mass.

The solid content of the self-dispersing polymer in the water-based ink composition of the present invention is, from the viewpoint of the glossiness of images, preferably from 1% by mass to 30% by mass, with respect to the water-based ink composition, and more preferably from 5% by mass to 15% by mass.

The content ratio of the water-insoluble colored particles to the water-insoluble particles (water-insoluble colored particles/water-insoluble particles) in the water-based ink composition of the present invention is, from the viewpoint of the scratch resistance of images, preferably from 1/0.5 to 1/10 and more preferably from 1/1 to 1/4.

Water-Soluble Organic Solvent

The water-based ink composition of the invention contains water as a solvent, and can further contain a water-soluble organic solvent. The water-soluble organic solvent can be contained as a drying inhibitor or a permeation accelerator.

Where the water-based ink composition of the invention is particularly applied to an image recording method by an inkjet method, the drying inhibitor can effectively prevent clogging of nozzle that may possibly be generated by drying of an ink at an ink jet orifice.

The drying inhibitor is preferably a water-soluble organic solvent having vapor pressure less than that of water. Specific examples of the drying inhibitor include polyhydric alcohols such as ethylene glycol, propylene glycol, diethylene glycol, polyethylene glycol, thiodiglycol, dithiodiglycol, 2-methyl-1,3-propanediol, 1,2,6-hexanetriol, acetylene glycol derivatives, glycerin and trimethylolpropane; lower alkyl ethers of polyhydric alcohol, such as ethylene glycol monomethyl (or ethyl)ether, diethylene glycol monomethyl (or ethyl)ether and triethylene glycol monoethyl (or butyl)ether; heterocycles such as 2-pyrrolidone, N-methyl-2-pyrrolidone, 1,3-dimethyl-2-imidazolidinone and N-ethylmorpholine; sulfur-containing compounds such as sulfolane, dimethylsufoxide and 3-sulfolene; polyfunctional compounds such as diacetone alcohol and diethanolamine; and urea derivatives. Above all, polyhydric alcohols such as glycerin and diethylene glycol are preferred as the drying inhibitor. These drying inhibitors may be used alone or in a combination of two kinds or more thereof. These drying inhibitors are preferably contained in an amount of from 10% by mass to 50% by mass in the ink.

The permeation accelerator is preferably used for the purpose of well permeating the ink into a recording medium (printing paper). Specific examples of the permeation accelerator include alcohols such as ethanol, isopropanol, butanol, di(tri)ethylene glycol monobutyl ether and 1,2-hexanediol; sodium lauryl sulfate, sodium oleate and nonionic surfactants. When the permeation accelerator is contained in the ink composition in an amount of from 5% by mass to 30% by mass, sufficient effect is exhibited. The permeation accelerator is preferably used within a range of the addition amount such that blurring of printing and print-through are not generated.

Furthermore, the water-soluble organic solvent is also usable to adjust viscosity besides the above. Specific examples of the water-soluble organic solvent usable for viscosity control may include: alcohols (for example, methanol, ethanol, propanol, isopropanol, butanol, isobutanol, sec-butanol, t-butanol, pentanol, hexanol, cyclohexanol, and benzyl alcohol); polyhydric alcohols (for example, ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thiodiglycol); glycol derivatives (for example, ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethylether acetate, triethylene glycol monomethyl ether, triethylene glycol monoethyl ether, and ethylene glycol monophenyl ether); amines (for example, ethanolamine, diethanolamine, triethanolamine, N-methyldiethanolamine, N-ethyldiethanolamine, morpholine, N-ethyl morpholine, ethylene diamine, diethylenetriamine, triethylenetetramine, polyethylene imine, and tetramethylpropylene diamine); and other polar solvents (for example, formamide, N,N-dimethylformamide, N,N-dimethylacetaamide, dimethyl sulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile, and acetone).

Note that, the water-soluble organic solvent may be used one kind alone or in a combination of two or more kinds.

—Other Additives—

In the present invention, the water-based ink composition may contain the other additives besides the above components.

Examples of the other additives which can be used in the invention include conventional additives such as color fading inhibitor, emulsion stabilizer, permeation accelerator, ultraviolet absorbent, preservative, mildew-proofing agent, pH regulator, surface tension regulator, defoamer, viscosity regulator, dispersant, dispersion stabilizer, anti-rust agent and chelating agent. These various additives may directly be added after preparation of the water-based ink composition, or may be added at the time of preparation of the water-based ink composition.

The ultraviolet absorbent is used for the purpose of improving preservability of an image. Examples of the ultraviolet absorbent that can be used include benzotriazole compounds described in, for example, JP-A Nos. 58-185677, 61-190537, 2-782, 5-197075 and 9-34057; benzophenone compounds described in, for example, JP-A Nos. 46-2784 and 5-194483, and U.S. Pat. No. 3,214,463; cinnamic acid compounds described in, for example, Japanese Patent Application Publication (JP-B) Nos. 48-30492 and 56-21141, and JP-A No. 10-88106; triazine compounds described in, for example, JP-A Nos. 4-298503, 8-53427, 8-239368 and 10-182621, and Japanese National Phase Publication No. 8-501291; compounds described in Research Disclosure No. 24239; and compounds that absorb ultraviolet light and emit fluorescence, i.e., fluorescent brighteners, represented by stilbene compounds or benzoxazole compounds.

The color fading inhibitor is used for the purpose of improving storability of an image. Examples of the color fading inhibitor that can be used include various organic color fading inhibitors and metal complex color fading inhibitors. Examples of the organic color fading inhibitor include hydroquinones, alkoxyphenols, dialkoxyphenols, phenols, anilines, amines, indanes, chromanes, alkoxyanilines and heterocycles. Examples of the metal complex color fading inhibitor include a nickel complex and a zinc complex. More specifically, compounds described in the patents cited in Research Disclosure No. 17643, chapter VII, items Ito J; Research Disclosure No. 15162: Research Disclosure No. 18716; page 650, the left-hand column; Research Disclosure No. 36544, page 527; Research Disclosure No. 307105, page 872; and Research Disclosure No. 15162, and compounds included in the formulae of the representative compounds and the exemplified compounds described on pages 127 to 137 of JP-A No. 62-215272 can be used.

Examples of the mildew-proofing agent include sodium dehydroacetate, sodium benzoate, sodium pyridinethion-1-oxide, p-hydroxybenzoic acid ethyl ester, 1,2-benzisothiazolin-3-one and its salt. These are preferably used in the water-based ink composition in an amount of from 0.02% by mass to 1.00% by mass.

As the pH regulator, a neutralizer (organic base or inorganic alkali) may be used. The pH regulator may be added in an amount such that the water-based ink composition has pH of preferably from 6 to 10, and more preferably from 7 to 10, for the purpose of improving storage stability of the water-based ink composition.

Examples of the surface tension regulator include nonionic surfactants, cationic surfactants, anionic surfactants and betaine surfactants.

The surface tension regulator is added in an amount such that the surface tension of the water-based ink composition is adjusted to preferably from 20 mN/m to 60 mN/m, more preferably from 20 mN/m to 45 mN/m, and further preferably from 25 mN/m to 40 mN/m, in order to well eject the water-based ink composition by an inkjet method. On the other hand, when an ink is applied by a method other than an inkjet method, the surface tension is preferably in a range of from 20 mN/m to 60 mN/m, and more preferably in a range of from 30 mN/m to 50 mN/m.

The surface tension of the water-based ink composition can be measured using, for example, a plate method.

Specific examples of the surfactant as a hydrocarbon type preferably include anionic surfactants such as fatty acid salts, alkyl sulfate ester salts, alkyl benzene sulfonates, alkyl naphthalene sulfonates, dialkyl sulfosuccinates, alkyl phosphate ester salts, naphthalenesulfonic acid-formalin condensates and polyoxyethylene alkyl sulfate ester salts; and nonionic surfactants such as polyoxyethylene alkyl ether, polyoxyethylene alkyl allyl ether, polyoxyethylene fatty acid ester, sorbitan fatty acid ester, polyoxyethylene sorbitan fatty acid ester, polyoxyethylene alkyl amine, glycerin fatty acid ester and oxyethylene oxypropylene block copolymer. SURFYNOLS (trade name, products of Air Products & Chemicals) which are an acetylene type polyoxyethylene oxide surfactant are preferably used. Furthermore, amine oxide type amphoteric surfactants such as N,N-dimethyl-N-alkyl amine oxide are preferred.

Additionally, materials described on pages (37) to (38) of JP-A No. 59-157636 and Research Disclosure No. 308119 (1989) as surfactants can be used.

When fluorocarbon (alkyl fluoride type) surfactants, silicone surfactants and the like, such as those described in JP-A Nos. 2003-322926, 2004-325707 and 2004-309806 are used, scratch resistance can be improved.

The surface tension regulator can be used as a defoamer, and fluorine compounds, silicone compounds, chelating agents represented by EDTA, and the like can be used.

When the ink is applied by an inkjet method, the water-based ink composition of the invention has a viscosity preferably in a range of from 1 mPa·s to 30 mPa·s, more preferably in a range of from 1 mPa·s to 20 mPa·s, further preferably in a range of from 2 mPa·s to 15 mPa·s, and particularly preferably in a range of from 2 mPa·s to 10 mPa·s, from the standpoints of droplet ejection stability and aggregation speed.

When the ink is applied by a method other than an inkjet method, the viscosity is preferably in a range of from 1 mPa·s to 40 mPa·s, and more preferably in a range of from 5 mPa·s to 20 mPa·s.

The viscosity of the water-based ink composition can be measured using, for example, a Brookfield viscometer.

<Ink Set>

An ink set of the invention contains at least one kind of the water-based ink composition.

The ink set of the invention can be used for a recording method using the water-based ink composition, and is preferable as an ink set specifically used for an inkjet recording method. Moreover, the ink set of the invention is preferable, for example, in that it can be used in the form of an ink cartridge which houses the ink set integrally or independently and the handling thereof is convenient. An ink cartridge containing an ink set is known in this technical field, and the ink set of the invention can be used as an ink cartridge suitably using known methods.

<Image Forming Method>

An image forming method of the invention includes applying the water-based ink composition to a recording medium using the water-based ink composition or the ink set.

While the water-based ink composition and the ink set of the invention can be used for generally-used pens, pencils, recorders, pen plotters, or the like, the water-based ink composition and the ink set of the invention can be particularly preferably used for an inkjet recording method. The scope of the inkjet recording method for which the water-based ink composition or the ink set of the invention can be used includes any recording methods including ejecting an ink composition as droplets from a nozzle to adhere the droplets to a recording medium. Specific examples of the inkjet recording method for which the water-based ink composition of the invention can be used will be described below.

A first specific example is a method referred to as an electrostatic suction method. The electrostatic suction method is: a method of recording an image by applying a strong electric field to a space between a nozzle and accelerating electrodes located in front of the nozzle, continuously jetting ink droplets from the nozzle, transmitting printing information signals to deflecting electrodes while the ink droplets pass between the deflecting electrodes, thereby causing the ink droplets to fly toward the surface of a recording medium to fix the ink onto the recording medium; or a method of recording an image by jetting ink droplets from a nozzle toward the surface of a recording medium according to printing information signals, without deflecting the ink droplets, to thereby fix an image onto the recording medium droplets. The water-based ink composition or the ink set of the invention can be preferably used for the electrostatic suction method.

A second specific example is a method including applying pressure to an ink liquid with a small-sized pump and, at the same time, mechanically vibrating an inkjet nozzle with a quartz oscillator or the like to thereby forcibly jet ink droplets from the nozzle. According to the method, the ink droplets jetted from the nozzle are electrically charged simultaneously with being jetted, and printing information signals are transmitted to deflecting electrodes while the ink droplets pass between the deflecting electrodes, so that the ink droplets are caused to fly toward a recording medium, and thereby an image is recorded onto the recording medium. The water-based ink composition or the ink set of the invention can be preferably used for this recording method.

A third specific example is a method (piezo) including: applying pressure and printing information signals simultaneously to an ink liquid by a piezoelectric element; allowing ink droplets to jet toward a recording medium from a nozzle; and recording an image on the recording medium. It is preferable that the water-based ink composition or the ink set of the present invention is used in this recording method.

A fourth specific example is a method including: heating and foaming an ink liquid using a micro electrode in accordance with printing information signals; jetting the ink liquid toward a recording medium from a nozzle by expanding the resulting foams; and recording an image on the recording medium. It is preferable that the water-based ink composition or the ink set of the present invention is used in this recording method.

There is no particular limitation on a recording medium which can be used in the invention, and examples thereof include a regular paper, a fine paper, and a coated paper.

The water-based ink composition or the ink set of the present invention is particularly preferably used as an ink composition when an image is recorded on a recording medium by using an image recording method in accordance with an inkjet recording system that includes the foregoing four methods. Recorded articles that are recorded by using the water-based ink composition or the ink set of the present invention have excellent image quality and also excellent ink fixability.

### EXAMPLES

The present invention will now be explained in detail with reference to the following examples, but it should be construed that the invention is in no way limited to those examples. Note that, if not otherwise specified, “part(s)” and “%” are on the basis of mass.

### Preparation of Water-Based Dispersion of a Self-Dispersing Polymer

### Example 1

In a 2 L three-necked flask equipped with an agitator, a thermometer, a reflux condenser tube, and a nitrogen gas introduction pipe, 560.0 g of methyl ethyl ketone were charged and the temperature was elevated to 87° C. While the inside of the reaction vessel was kept in a refluxing state (refluxing was continued until the reaction was ended), a mixed solution containing 272.6 g of methyl methacrylate, 58.0 g of 2-methoxyethyl acrylate, 203.0 g of benzyl methacrylate, 46.4 g of methacrylic acid, 108 g of methyl ethyl ketone, and 2.32 g of “V-601” (trade name, manufactured by Wako Pure Chemical Industries, Ltd.) was added dropwise at a constant speed in a manner such that the dropwise addition was completed in 2 hours. After the dropwise addition was completed, and after 1 hour of agitation, (1) a solution containing 1.16 g of “V-601” and 6.4 g of methyl ethyl ketone was added, and then 2 hours of agitation was performed. The step (1) was repeated four times, and then a solution that contained 1.16 g of “V-601” and 6.4 g of methyl ethyl ketone was further added, and agitation was continued for 3 hours. The weight-average molecular weight (Mw) of the resulting copolymer was 56,000 (determined by gel permeation chromatography (GPC) in teems of polystyrene, using the columns of TSKgel Super HZM-H, TSKgel Super HZ4000, and TSKgel Super HZ200 (trade names, manufactured by TOSOH CORP.).

—Phase Transfer Step—

After that, 291.5 g (solid content: 44.6%) of the resulting polymerization solution were weighed out; then, 82.5 g of isopropanol, 3.25 g of a 20% maleic acid aqueous solution (water-soluble electrolyte, corresponding to 0.5% with respect to the copolymer), and 73.92 g of a 1 mol/L NaOH aqueous solution were added thereto; and the temperature inside of the reaction vessel was elevated to 87° C. Then, 352 g of distilled water were added thereto dropwise at a rate of 10 mL/min so as to prepare a water-based dispersion (dispersing step). The dispersion was kept under an atmospheric pressure while the temperature inside of the reaction vessel was maintained at 87° C. for 1 hour, at 91° C. for another 1 hour, and at 95° C. for 30 minutes. The inside of the reaction vessel was depressurized so as to distill out isopropanol, methyl ethyl ketone, and distilled water in a total amount of 287.0 g (solvent removal step) and to obtain a water-based dispersion (B-01Lx) of a self-dispersing polymer (B-01) with a solid content of 26.5%. Note that, the numerical character of each constituent unit of the following exemplary compound (B-01) shows a mass ratio. Hereinafter, each structural formula is shown in the same way.

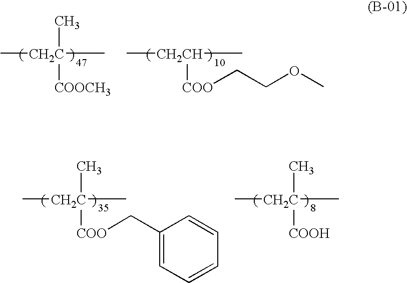

### Example 2

In a manner substantially similar to that in Example 1, the following exemplary self-dispersing polymers (B-02) to (B-10) were obtained, and water-based dispersions of self-dispersing polymer (B-02Lx) to (B-13Lx) were obtained therefrom, except that, in the synthesis of (B-01) in Example 1, in place of methyl methacrylate, methoxyethyl acrylate, benzyl methacrylate, and methacrylic acid, the kind and mixing ratio of each monomer were changed in accordance with the mass ratio of the following exemplary compounds, and that the kind and amount of the neutralization base and the water-soluble electrolyte were changed as shown in Table 1. The physical properties of the resulting water-based dispersions of self-dispersing polymer (B-02Lx) to (B-13Lx) are shown in Table 1.

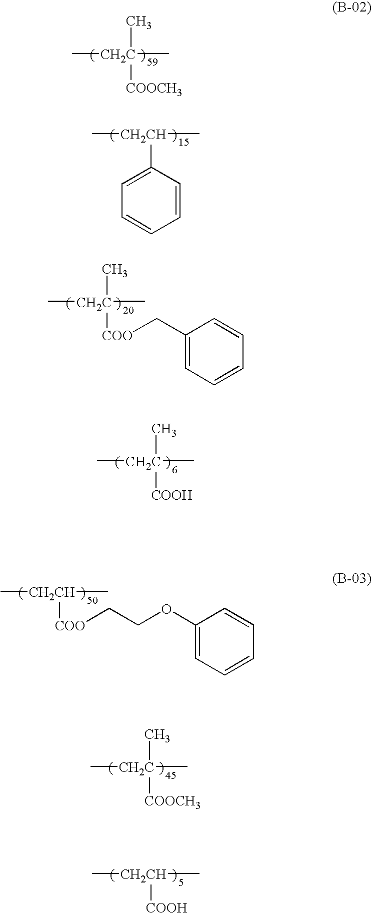

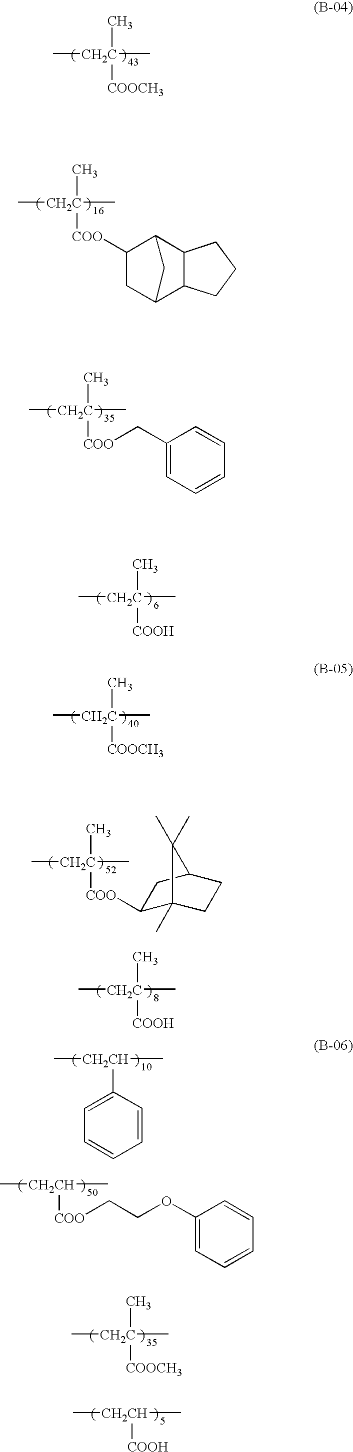

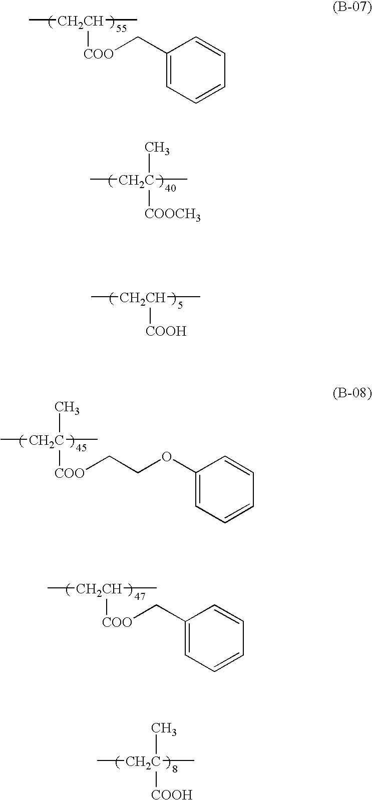

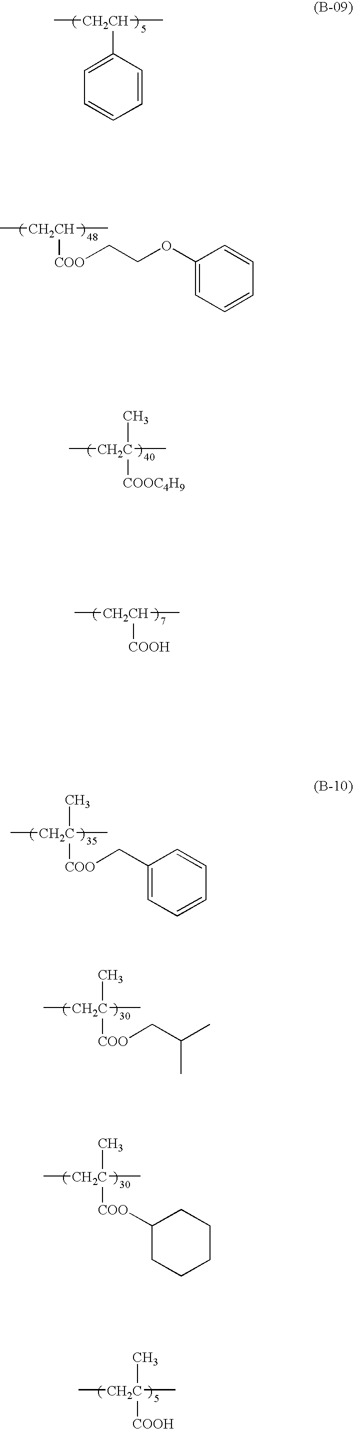

In a manner substantially similar to that in Example 1, a water-based dispersion of a self-dispersing polymer (B-14Lx) was obtained, except that, in the step (phase transfer step) of obtaining the water-based dispersion (B-01Lx) in Example 1, the step of adding the maleic acid aqueous solution serving as a water-soluble electrolyte was conducted after the solvent removal step of removing the solvents under vacuum. The physical properties of the resulting water-based dispersion of a self-dispersing polymer (B-14Lx) are shown in Table 1.

### Comparative Example 1

In a manner substantially similar to that in Example 1, a water-based dispersion of a self-dispersing polymer (BH-01Lx) was obtained, except that the water-soluble electrolyte (maleic acid) was not added in the step (phase transfer step) of obtaining the water-based dispersion (B-01) of Example 1.

### Comparative Example 2

In a manner substantially similar to that in the production example of self-emulsifying polymer particles described in the paragraph 0041 of JP-A No. 2006-283003, a water-based dispersion (BH-02Lx) of the following exemplary compound (BH-01) was obtained, except that the kind and amount of the neutralization base were changed as shown in Table 1. Note that, in the exemplary compound, “AS-6S” is a trade name of styrene macromer (manufactured by Toagosei Co., Ltd.), and “NK ESTER EH-4G” is a trade name of polyethyleneglycol methacrylate 2-ethylhexyl ether (manufactured by Shin-Nakamura Chemical Co., Ltd.). The physical properties of the resulting water-based dispersion (BH-02Lx) are shown in Table 1.

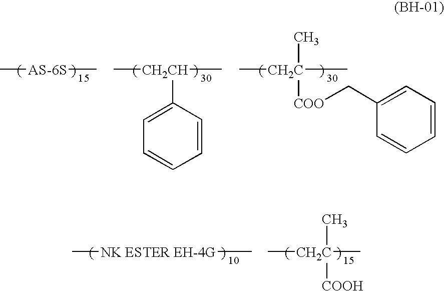

### Comparative Example 3

In accordance with the production example described in the paragraph 0027 of JP-A No. 2000-319329, butadiene latex was obtained in the presence of a water-soluble electrolyte. The physical properties of the resulting water-based dispersion (BH-03Lx) are shown in Table 1.

TABLE 1

| | | Neutralization base | | Particle | Weight-average | Water-soluble electrolyte | | | |
|---|---|---|---|---|---|---|---|---|---|
| Water-based | Self-dispersing | | Neutralization | diameter | molecular | | Addition | | |
| dispersion | polymer | Kind | degree (%) | (nm) | weight | Kind | amount (%) | Stability | Remarks |
| B-01Lx | B-01 | NaOH | 50 | 4.5 | 55,000 | Maleic acid | 0.5 | A | Present invention |
| B-02Lx | B-02 | NaOH | 70 | 3.5 | 58,000 | Na₂SO₄ | 0.3 | A | Present invention |
| B-03Lx | B-03 | NaOH | 75 | 6.5 | 59,000 | Maleic acid | 0.3 | A | Present invention |
| B-04Lx | B-04 | Amm | 80 | 7.5 | 66,000 | Tartaric acid | 0.2 | A | Present invention |
| B-05Lx | B-05 | TEA | 90 | 5.5 | 52,000 | Maleic acid | 0.6 | A | Present invention |
| B-06Lx | B-06 | TEA | 85 | 12 | 72,000 | NaCl | 0.7 | A | Present invention |
| B-07Lx | B-07 | Amm | 65 | 25 | 62,000 | Tartaric acid | 0.8 | A | Present invention |
| B-08Lx | B-08 | NaOH | 70 | 76 | 61,000 | NaCl | 8.6 | A | Present invention |
| B-09x | B-09 | NaOH | 80 | 8.0 | 57,000 | Maleic acid | 0.05 | A | Present invention |
| B-10Lx | B-10 | Amm | 90 | 36 | 73,000 | Maleic acid | 3.6 | A | Present invention |
| B-11Lx | B-02 | NaOH | 120 | 0.05 | 39,000 | Maleic acid | 0.008 | B | Present invention |
| B-12Lx | B-03 | TEA | 40 | 90 | 80,000 | Malic acid | 10.8 | B | Present invention |
| B-13Lx | B-01 | NaOH | 55 | 5.1 | 55,000 | Maleic acid, Na salt | 0.6 | A | Present invention |
| B-14Lx | B-01 | NaOH | 50 | 4.8 | 55,000 | Maleic acid* | 0.5 | A | Present invention |
| BH-01Lx | B-01 | NaOH | 50 | 0.04 | 55,000 | None | — | B | Comparative |
| | | | | | | | | | Example |
| BH-02Lx | BH01 | NaOH | 70 | 108 | 56,000 | None | — | C | Comparative |
| | | | | | | | | | Example |
| BH-03Lx | Butadiene | — | — | 118 | 200,000 | Na₂SO₄ | 0.74 | C | Comparative |
| | | | | | | | | | Example |

*Added after solvent removal step.
Note that, in Table 1, abbreviations are as follows.
NaOH: sodium hydroxide,
Amm: ammonia water (2.8% aqueous solution),
TEA: triethylamine,
Na₂SO₄: sodium sulfate, and
NaCl: sodium chloride.

The addition amount of the water-soluble electrolyte is shown in % by mass with respect to the copolymer solid content. The particle diameter shown in Table 1 is a volume average diameter that was measured by a dynamic light scattering method within 24 hours after the water-based dispersion was prepared, namely, measured through a conventional procedure using “Microtrac UPA EX-150” (trade name, manufactured by NIKKISO Co., Ltd.).

The water-based dispersions of polymer obtained above were subjected to evaluation with respect to stability as follows.

Each water-based dispersion in an amount of 10 mL was sealed in each 15 mL glass bottle and stored at 60° C. for 14 days, and then the average particle diameter was measured. Percent of change in the average diameter between before and after storage [(average diameter after storage average diameter before storage)/average diameter before storage] was calculated and evaluated in accordance with the following evaluation criteria.

—Evaluation Criteria—

A: the percent of change in the average diameter is less than 10%.

B: the percent of change in the average diameter is 10% or more but less than 50%.

C: the percent of change in the average diameter is 50% or more.

### Example 3

### Preparation of Water-Based Ink Composition

<<Preparation of Cyan Ink C-1>>

(Preparation of Cyan Dispersion Liquid Serving as Water-Insoluble Colored Particles)

In a reaction vessel, a mixed solution was prepared, which was composed of 6 parts of styrene, 11 parts of stearyl methacrylate, 4 parts of “STYRENE MACROMER AS-6” (trade name, manufactured by TOAGOSEI Co., Ltd.), 5 parts of “BLENMER PP-500” (trade name, NOF Corp.), 5 parts of methacrylic acid, 0.05 parts of 2-mercaptoethanol, and 24 parts of methyl ethyl ketone.

On the other hand, another mixed solution that was composed of 14 parts of styrene, 24 parts of stearyl methacrylate, 9 parts of “STYRENE MACROMER AS-6” (trade name, manufactured by TOAGOSEI Co., Ltd.), 9 parts of “BLENMER PP-500” (trade name, NOF Corp.), 10 parts of methacrylic acid, 0.13 parts of 2-mercaptoethanol, 56 parts of methyl ethyl ketone, and 1.2 parts of 2,2′-azobis(2,4-dimethyl valeronitrile) was prepared and put in a dropping funnel.

After that, in a nitrogen gas atmosphere, the temperature of the mixed solution in the reaction vessel was elevated to 75° C. while agitating, and the mixed solution in the dropping funnel was added thereto dropwise over 1 hour. When 2 hours passed after the dropwise addition was completed, a solution obtained by dissolving 1.2 parts of 2,2′-azobis(2,4-dimethyl valeronitrile) in 12 parts of methyl ethyl ketone was added thereto dropwise over 3 hours. After 2 hour aging at 75° C. and another 2 hour aging at 80° C., a polymer dispersant solution was obtained.

Concerning a part of the obtained polymer dispersant solution, the solvents were removed to separate the solid. The solid thus separated was diluted into 0.1% by mass with tetrahydrofuran and the weight average molecular weight thereof was measured by GPC. The separated solid had a weight average molecular weight of 25,000 calculated in terms of polystyrene.

The resulting polymer dispersant solution in a solid amount of 5.0 g, a cyan pigment of Pigment Blue 15:3 (trade name, manufactured by Dainichiseika Color & Chemicals Mfg. Co., Ltd.) in an amount of 10.0 g, methyl ethyl ketone in an amount of 40.0 g, 1 mol/L sodium hydroxide in an amount of 8.0 g, ion-exchanged water in an amount of 82.0 g, and 0.1 mm zirconia beads in an amount of 300 g were charged in a vessel and dispersed using a “READY MILL” disperser (trade name, manufactured by Aimex Corp.) at 1,000 rpm for 6 hours. The resulting dispersion liquid was vacuum-concentrated with an evaporator until methyl ethyl ketone was sufficiently distilled out, and further concentrated until the pigment concentration became 10%, so that a cyan dispersion liquid C1 serving as water-insoluble colored particles was prepared. The average particle diameter of the resulting cyan dispersion liquid C1 was 77 nm.

Then, by using the cyan dispersion liquid C1 serving as water-insoluble colored particles and the water-based dispersion of a self-dispersing polymer B-01Lx, an ink was prepared in a manner that the following ink composition was obtained. After preparation, crude particles were removed using a 5 μm filter. In this way, a cyan ink C-1 serving as a water-based ink composition was prepared.

<Ink composition of Cyan Ink C-1>

| | |
|---|---|
| Cyan pigment (Pigment Blue 15:3, trade name, | 4% |
| manufactured by Dainichiseika Color & Chemicals | |
| Mfg. Co., Ltd.) | |
| The foregoing polymer dispersant | 2% |
| B-01Lx (in terms of solid content) | 8% |
| Diethylene glycol monoethyl ether (water-soluble | 10% |
| solvent, manufactured by Wako Pure Chemical | |
| Industries, Ltd.) | |
| “SANNIX GP250” (trade name, water-soluble | 5% |
| solvent, manufactured by Sanyo Chemical | |
| Industries, Ltd.) | |
| “OLFIN E1010” (trade name, manufactured | 1% |
| by Nissin Chemical Industry Co., Ltd.) | |
| Ion-exchanged water | added in a manner |
| | that the total amount |
| | of the composition |
| | becomes 100% |

<<Preparation of Cyan Inks C-2 to C-14 and CH-1 to CH-4>>

Each of cyan inks C-2 to C-14 and CH-1 to CH-4, each serving as a water-based ink composition, was prepared in a manner similar to the method of preparing the cyan ink C-1, except that each water-based dispersion of polymer shown in the following Table 2 was used in place of the water-based dispersion of a self-dispersing polymer B-01Lx used for the cyan ink C-1. Note that, the cyan ink CH-4 was prepared without using a water-based dispersion of polymer.

The physical properties measured immediately after the cyan inks were prepared are shown in Table 2.

TABLE 2

| | | | Particle | |
|---|---|---|---|---|
| | Water-based | | diameter | |
| Cyan ink | dispersion | Viscosity | (nm) | Remarks |
| C-1 | B-01Lx | A | 87 | Present invention |
| C-2 | B-02Lx | A | 86 | Present invention |
| C-3 | B-03Lx | A | 91 | Present invention |
| C-4 | B-04Lx | A | 90 | Present invention |
| C-5 | B-05Lx | A | 91 | Present invention |
| C-6 | B-06Lx | A | 87 | Present invention |
| C-7 | B-07Lx | A | 91 | Present invention |
| C-8 | B-08Lx | A | 85 | Present invention |
| C-9 | B-09Lx | A | 86 | Present invention |
| C-10 | B-10Lx | A | 87 | Present invention |
| C-11 | B-11Lx | A | 98 | Present invention |
| C-12 | B-12Lx | A | 98 | Present invention |
| C-13 | B-13Lx | A | 90 | Present invention |
| C-14 | B-14Lx | A | 91 | Present invention |
| CH-1 | BH-01Lx | B | 105 | Comparative Example |
| CH-2 | BH-02Lx | B | 110 | Comparative Example |
| CH-3 | BH-03Lx | C | 108 | Comparative Example |
| CH-4 | — | A | 90 | Comparative Example |

Note that, in Table 2, the viscosity was evaluated in accordance with the following evaluation criteria.
Evaluation criteria
A: less than 6.5 mPa · s,
B: 6.5 mPa · s or more but less than 10 mPa · s, and
C: 10 mPa · s or more.

[Evaluation]

A stability over time test on the ink, a droplet ejection stability test on the ink and a fixability test on images formed of the ink were conducted on each ink prepared above. The stability over time test on an ink is to evaluate stability of particle diameter and viscosity of an ink before ejecting the ink, that is, the stability of particle diameter and viscosity of the ink that is stored in an ink storage tank (or cartridge). When the stability is poor, droplet ejection nozzle can be clogged when ejecting an ink from an ejection nozzle of an inkjet apparatus. The droplet ejection stability test on an ink is intended to evaluate the ejection directional property. When the viscosity of an ink is high, the ejection directional property can be poor due to occurrence of clogging of ejection nozzles.

(Test for Ink Stability Over Time)

10 mL of each of the inks was sealed in each 15 mL glass bottle. Then, (1) the average particle diameter and viscosity after leaving at 60° C. for 14 days and (2) the average particle diameter and viscosity after leaving at 40° C. for 3 months were measured for each ink. The changes in the average particle diameter before and after the leaving [(the average particle diameter after leaving—the average particle diameter before leaving)/the average particle diameter before leaving] and the changes in the viscosity before and after leaving [(the viscosity after leaving—the viscosity before leaving)/the viscosity before leaving] were respectively calculated. The evaluation criteria are as follows.

### Evaluation Criteria of Stability Over Time:

A: The change in the average particle diameter or the change in the viscosity is less than 5%.

B: The change in the average particle diameter or the change in the viscosity is 5% or more but less than 10%.

C: The change in the average particle diameter or the change in the viscosity is 10% or more.

C indicates that the ink is evaluated to be unusable. Results are shown in Table 3.

(Droplet Ejection Stability Test)

A droplet election stability test was performed as follows. Ink droplets were ejected onto “TOKUBISHI ART PAPER DOUBLE-SIDED N” (trade name, manufactured by Mitsubishi Paper Mills Limited), using a printer head “GELJETG717” (trade name, manufactured by Ricoh Company, Ltd.), at a resolution of 1,200 dpi x600 dpi and an ink droplet ejection amount of 12 pL. Droplet ejection stability was evaluated by observing the state of 5 hours later after continuous ejection of droplets. The obtained results are shown in Table 3. Note that, the evaluation criteria for the droplet ejection stability test shown in Table 3 are as follows. Note that, C indicates that the ink was evaluated to be unusable.

—Evaluation Criteria—

A: no ejection failure and no directional failure,

B: almost no ejection failure, but directional failure occurs a little, and

C: ejection failures occur frequently.

(Fixability Test)

The ink was refilled in a cartridge of a printer head GELJETG717. A solid image was printed on “TOKUBISHI ART PAPER DOUBLE-SIDED N” (trade name, manufactured by Mitsubishi Paper Mills Limited) using the printer head GELJETG717. After printing, the printed sample was dried at room temperature for at least 24 hours. After drying, the sample was left for 1 hour while heated at 60° C. in a heating oven “PDR-3 KP” (trade name, manufactured by ESPEC Corp.), further left for 12 hours, and was subjected to evaluation with respect to fixability. Results are shown in Table 3. Note that, the evaluation criteria for fixability shown in Table 3 are as follows. A Cellophane tape (trade name, manufactured by NICHIBAN Co., Ltd.) and a mending tape (manufactured by 3M Corp.) were applied onto the entire face of the printed sample and then immediately peeled off. Color transfer to the tapes after peeled off was evaluated in accordance with the following evaluation criteria.

—Evaluation Criteria—

A: no color transfer is recognized on both of the cellophane tape and the mending tape,

B: color transfer is recognized on either of the cellophane tape and the mending tape, and

C: color transfer is recognized on both of the cellophane tape and the mending tape.

TABLE 3

| | | Test for ink stability | | | | | | |
|---|---|---|---|---|---|---|---|---|
| | | over time | | | | Droplet | | |
| | | | | Particle | | ejection | | |
| Cyan | Water-based | Viscosity | | diameter | | stability | Fixability | |
| ink | dispersion | (1) | (2) | (1) | (2) | test | test | Remarks |
| C-1 | B-01Lx | A | A | A | A | A | A | Present invention |
| C-2 | B-02Lx | A | A | A | A | A | A | Present invention |
| C-3 | B-03Lx | A | A | A | A | A | A | Present invention |
| C-4 | B-04Lx | A | A | A | A | A | A | Present invention |
| C-5 | B-05Lx | A | A | A | A | A | A | Present invention |
| C-6 | B-06Lx | A | A | A | A | A | A | Present invention |
| C-7 | B-07Lx | A | A | A | A | A | A | Present invention |
| C-8 | B-08Lx | A | B | A | B | A | A | Present invention |
| C-9 | B-09Lx | A | A | A | B | A | A | Present invention |
| C-10 | B-10Lx | A | A | A | A | A | A | Present invention |
| C-11 | B-11Lx | A | B | A | B | B | A | Present invention |
| C-12 | B-12Lx | A | B | A | B | B | A | Present invention |
| C-13 | B-13Lx | A | A | A | A | A | A | Present invention |
| C-14 | B-14Lx | A | A | A | A | A | A | Present invention |
| CH-1 | BH-01Lx | B | C | B | B | B | B | Comparative |
| | | | | | | | | Example |
| CH-2 | BH-02Lx | C | B | C | B | B | B | Comparative |
| | | | | | | | | Example |
| CH-3 | BH-03Lx | B | C | C | C | C | B | Comparative |
| | | | | | | | | Example |
| CH-4 | None | A | A | A | A | A | C | Comparative |
| | | | | | | | | Example |

As is clear from Table 1, the water-based dispersions of self-dispersing polymer B-01Lx to B-14Lx have a small average particle diameter of from 0.05 nm to 90 nm, because water-soluble electrolytes were added to them. To the contrary, the comparative water-based dispersions of self-dispersing polymer BH-02Lx and BH-03Lx have a large average particle diameter of 108 nm or more. Further, BH-01Lx to which no water-soluble electrolyte was added has a small average particle diameter of 0.04 nm and the water-based dispersion itself has poor stability. These results suggest that the water-based dispersions of self-dispersing polymer according to the present invention are more excellent in dispersion stability. These results reflect the ink viscosity shown in Table 2, that is, all of the ink viscosities of Examples of the present invention are low, but the ink viscosities of Comparative Examples tend to be high.

Further, as is clear from Table 3, the inks of the present invention are excellent in stability over time. To the contrary, CH-1 to CH-3 that are inks having low stability and high ink viscosity have a tendency of increasing viscosity and particle diameter with time. Still further, all of the inks according to the present invention are low in the ink viscosity, so that they are free of ejection failure and are excellent in droplet ejection stability. To the contrary, CH-1 to CH-3 that are high in ink viscosity and are low in dispersion stability are low in droplet ejection stability. Furthermore, C-1 to C-14 that contain a water-based dispersion of a self-dispersing polymer produced by the manufacturing method in accordance with the present invention have a good fixability. To the contrary, CH-1 to CH-3 that contain a water-based dispersion of a self-dispersing polymer produced by a manufacturing method other than that of the present invention are insufficient in fixability. Note that, CH-4 that contains no water-based dispersion in the ink composition has a large drawback in fixability.

The above results show that, by using an ink composition that contains a water-based dispersion of a self-dispersing polymer of the present invention and is characterized by the manufacturing method thereof, an ink composition having a high ink stability, a stable ejection property, and a good fixability is obtainable.

The present invention includes the following embodiments.

<1> A method for manufacturing a water-based dispersion of a self-dispersing polymer including: obtaining a copolymer solution that contains a copolymer having a hydrophilic constituent unit and a hydrophobic constituent unit, and a solvent that dissolves the copolymer; obtaining a water-based dispersion of the copolymer through dispersion using the copolymer solution and water; and adding a water-soluble electrolyte selected from an acidic compound and a salt thereof to either or both of the copolymer solution and the water-based dispersion.
<2> The method for manufacturing a water-based dispersion of a self-dispersing polymer as described in <1>, wherein the water-based dispersion of a self-dispersing polymer contains the water-soluble electrolyte in an amount of from 0.01% by mass to 10% by mass with respect to the copolymer.
<3> The method for manufacturing a water-based dispersion of a self-dispersing polymer as described in <1>, wherein the water-soluble electrolyte is at least one kind selected from a carboxy group-containing acidic compound, a salt thereof, or an inorganic acid salt.
<4> The method for manufacturing a water-based dispersion of a self-dispersing polymer as described in <3>, wherein the water-soluble electrolyte is at least one kind selected from maleic acid, malic acid, tartaric acid, Na salts thereof, NaCl, or Na₂SO₄.
<5> The method for manufacturing a water-based dispersion of a self-dispersing polymer as described in <1>, wherein the solvent that dissolves the copolymer is at least one kind selected from a ketone-based solvent, an ether-based solvent, or an ester-based solvent, each having a boiling point of 100° C. or lower.
<6> The method for manufacturing a water-based dispersion of a self-dispersing polymer as described in <1>, wherein self-dispersing polymer particles in the water-based dispersion of a self-dispersing polymer have a volume average particle diameter of from 0.1 nm to 80 nm.
<7> The method for manufacturing a water-based dispersion of a self-dispersing polymer as described in <6>, wherein self-dispersing polymer particles in the water-based dispersion of a self-dispersing polymer have a volume average particle diameter of from 0.2 nm to 60 nm.
<8> The method for manufacturing a water-based dispersion of a self-dispersing polymer as described in <7>, wherein self-dispersing polymer particles in the water-based dispersion of a self-dispersing polymer have the volume average particle diameter of from 0.3 nm to 40 nm.
<9> The method for manufacturing a water-based dispersion of a self-dispersing polymer as described in <1>, wherein the water-based dispersion of a self-dispersing polymer further comprises a neutralizer which is at least one kind selected from sodium hydroxide, potassium hydroxide, ammonia triethylamine, or triethanolamine when the self-dispersing polymer has an anionic dissociative group as a dissociative group thereof.
<10> The method for manufacturing a water-based dispersion of a self-dispersing polymer as described in <1>, wherein a molecular weight of the self-dispersing polymer is in a range from 3,000 to 200,000 in terms of weight average molecular weight.
<11> The method for manufacturing a water-based dispersion of a self-dispersing polymer as described in <1>, wherein at least one kind of the hydrophilic constituent unit is a constituent unit having a carboxy group.
<12> The method for manufacturing a water-based dispersion of a self-dispersing polymer as described in <1>, wherein at least one kind of the hydrophobic constituent unit is a constituent unit derived from either or both of an acrylic acid ester monomer and a methacrylic acid ester monomer.
<13> A water-based ink composition including: water-insoluble colored particles that contain a coloring agent; and a water-based dispersion of a self-dispersing polymer that is produced by the method for manufacturing a water-based dispersion of a self-dispersing polymer as described in <1>.
<14> An ink set including at least one kind of the water-based ink composition as described in <13>.
<15> An image forming method including applying the water-based ink composition as described in <13> on a recording medium by using the water-based ink composition.
<16> An image forming method including applying the water-based ink composition on a recording medium by using the ink set as described in <14>.

All publications, patent applications, and technical standards mentioned in this specification are herein incorporated by reference to the same extent as if each individual publication, patent application, or technical standard was specifically and individually indicated to be incorporated by reference.

What is claimed is:

1. A method for manufacturing a water-based dispersion of a self-dispersing polymer, comprising:
obtaining a copolymer solution comprising a copolymer having a hydrophilic constituent unit and a hydrophobic constituent unit, and a solvent that dissolves the copolymer;
obtaining a water-based dispersion of the copolymer through dispersion using the copolymer solution and water; and
adding a water-soluble electrolyte selected from an acidic compound and a salt thereof to either or both of the copolymer solution and the water-based dispersion.

2. The method for manufacturing a water-based dispersion of a self-dispersing polymer according to claim 1, wherein the water-based dispersion of a self-dispersing polymer contains the water-soluble electrolyte in an amount of from 0.01% by mass to 10% by mass with respect to the copolymer.

3. The method for manufacturing a water-based dispersion of a self-dispersing polymer according to claim 1, wherein the water-soluble electrolyte is at least one selected from a carboxy group-containing acidic compound, a salt thereof, or an inorganic acid salt.

4. The method for manufacturing a water-based dispersion of a self-dispersing polymer according to claim 3, wherein the water-soluble electrolyte is at least one selected from maleic acid, malic acid, tartaric acid, Na salts thereof, NaCl, or Na₂SO₄.

5. The method for manufacturing a water-based dispersion of a self-dispersing polymer according to claim 1, wherein the solvent that dissolves the copolymer is at least one selected from a ketone-based solvent, an ether-based solvent, or an ester-based solvent, each having a boiling point of 100° C. or lower.

6. The method for manufacturing a water-based dispersion of a self-dispersing polymer according to claim 1, wherein self-dispersing polymer particles in the water-based dispersion of a self-dispersing polymer have a volume average particle diameter of from 0.1 nm to 80 nm.

7. The method for manufacturing a water-based dispersion of a self-dispersing polymer according to claim 6, wherein the self-dispersing polymer particles in the water-based dispersion of a self-dispersing polymer have a volume average particle diameter of from 0.2 nm to 60 nm.

8. The method for manufacturing a water-based dispersion of a self-dispersing polymer according to claim 7, wherein the self-dispersing polymer particles in the water-based dispersion of a self-dispersing polymer have a volume average particle diameter of from 0.3 nm to 40 nm.

9. The method for manufacturing a water-based dispersion of a self-dispersing polymer according to claim 1, wherein the water-based dispersion of a self-dispersing polymer further comprises a neutraizer which is at least one selected from sodium hydroxide, potassium hydroxide, ammonia, triethylamine, or triethanolamine when the self-dispersing polymer has an anionic dissociative group as a dissociative group thereof.

10. The method for manufacturing a water-based dispersion of a self-dispersing polymer according to claim 1, wherein a molecular weight of the self-dispersing polymer is in a range of from 3,000 to 200,000 in terms of weight average molecular weight.

11. The method for manufacturing a water-based dispersion of a self-dispersing polymer according to claim 1, wherein at least one of the hydrophilic constituent unit is a constituent unit having a carboxy group.

12. The method for manufacturing a water-based dispersion of a self-dispersing polymer according to claim 1, wherein at least one of the hydrophobic constituent unit is a constituent unit derived from either or both of an acrylic acid ester monomer and a methacrylic acid ester monomer.

13. A water-based ink composition comprising:
water-insoluble colored particles comprising a coloring agent; and
a water-based dispersion of a self-dispersing polymer produced by the method for manufacturing a water-based dispersion of a self-dispersing polymer according to claim 1.

14. An ink set comprising at least one of the water-based ink composition according to claim 13.

15. An image forming method comprising applying the water-based ink composition according to claim 13 on a recording medium by using the water-based ink composition.

16. An image forming method comprising applying the water-based ink composition on a recording medium by using the ink set according to claim 14.
